(19) United States
(12) Patent Application Publication
(10) Pub. No.: US 2005/0045215 A1
(43) Pub. Date: Mar. 3, 2005

(54) Three rack dishwasher with door mounted silverware basket

(75) Inventors: Scott D. Raches, Jackson, TN (US); James K. Starkweather, Jackson, TN (US); Wayne M. Vanlandingham, Jackson, TN (US)

Correspondence Address: MCKEE, VOORHEES & SEASE, P.L.C.;ATTN: MAYTAG, 801 GRAND AVENUE, SUITE 3200, DES MOINES, IA, 50309-2721, US

(73) Assignee: Maytag Corporation, Newton, IA (US)

(21) Appl. No.: 10/647,492

(22) Filed: Aug. 25, 2003

(51) Int. Cl. B08B 3/02

(52) U.S. Cl. 134/135; 134/95.3; 134/99.2; 134/103.1; 134/176; 134/179; 134/200

(57) ABSTRACT

A dishwasher is provided with three racks mounted in the cabinet for movement between extended and retracted positions, and utensil baskets removably mounted on the door. The door include hooks integrally molded with the inner wall of the door for receipt in slots on the back of the baskets, so that the baskets can be quickly and easily removed from the door for loading and unloading silverware, utensils, and other small objects to be washed. By mounting the baskets on the door, rack space and loading space is optimized.

### BACKGROUND OF THE INVENTION

Conventional dishwashers have two racks with one or two silverware baskets mounted within the upper or lower rack to hold silverware, utensils, and other objects for washing. Three rack dishwashers having upper, lower and middle racks are now being designed, such as disclosed in Applicant's co-pending application U.S. Ser. No. 10/156,414 filed on May 28, 2002. One problem with a three-rack dishwasher is the location of the silverware or utility basket. The baskets must be placed so as to have sufficient height to accommodate long utensils and silverware, such as knives and mixing spoons. However, a position which accommodates the required height for the objects to be washed in the basket eliminates space for other tall objects, such as dinner plates, large mixing bowls, and the like.

Therefore, a primary objective of the present invention is the provision of a dishwasher having three racks and having silverware baskets mounted on the door of the dishwasher.

Another objective of the present invention is the provision of a three rack dishwasher having door mounted silverware baskets which are quickly and easily installed on the door for loading and unloading.

Another objective of the present invention is the provision of a dishwasher having a door mounted utensil basket with a removable cover to retain smaller items in the basket during the wash operation.

These and other objectives will become apparent from the following description of the invention.

### SUMMARY OF THE INVENTION

The dishwasher of the present invention includes a cabinet defining a washing chamber, and a door pivotally mounted to the cabinet for movement between open and closed positions. The dishwasher includes an upper rack, a lower rack, and a middle rack, each being mounted in the cabinet for movement between a retracted wash position and an extended loading and unloading position. A pair of silverware baskets are removably mounted on hooks molded to the inside surface of the door. The baskets each have an open upper end, and a cover that is removable from the upper end. Each basket has a handle extending upwardly along the inside surface of the door for easy handling of the baskets.

### BRIEF DESCRIPTION OF THE DRAWINGS

FIG. 1 is a front elevation view of the dishwasher of the present invention with the door in an open position.

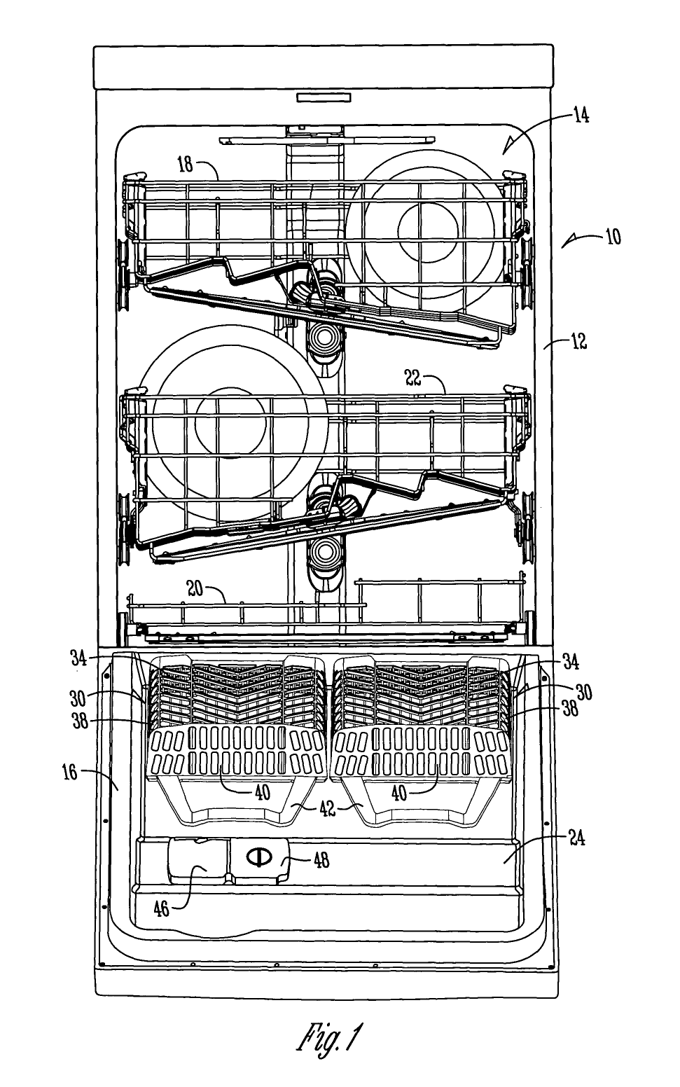

FIG. 2 is a perspective view of the dishwasher door with one basket mounted thereon, and one basket removed.

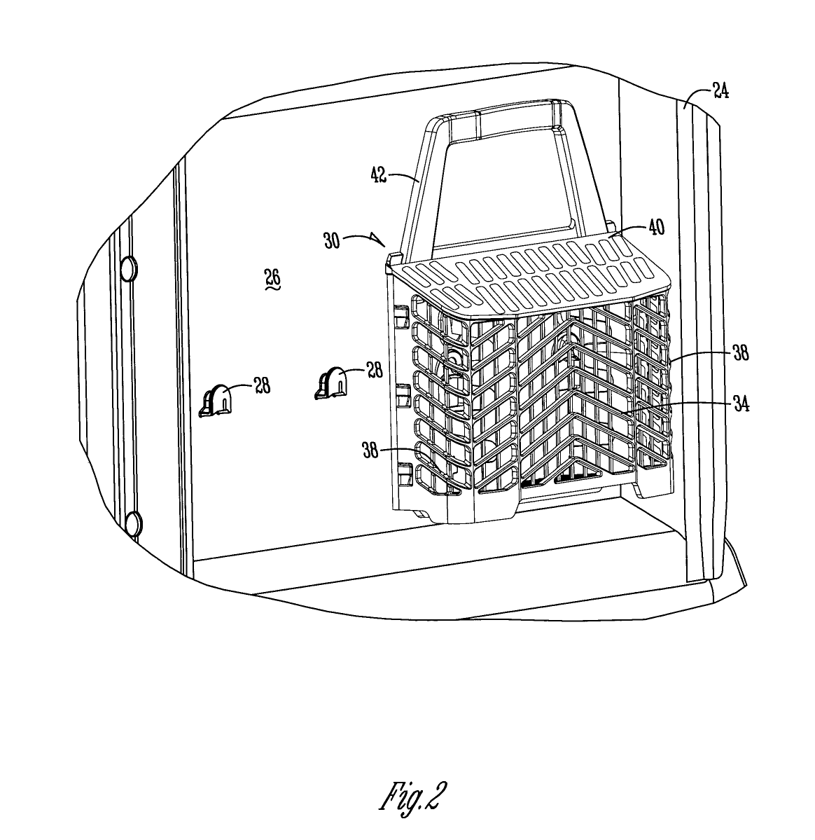

FIG. 3 is a rear perspective view of one of the baskets.

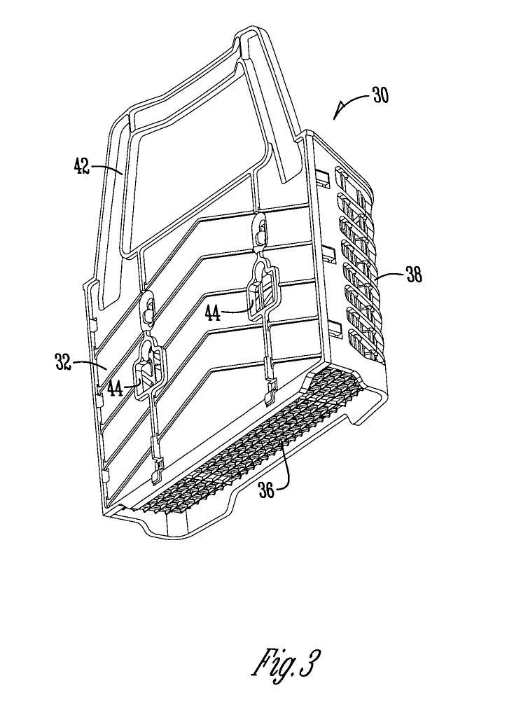

### DETAILED DESCRIPTION OF THE PREFERRED EMBODIMENT

The dishwasher of the present invention is generally designated by the reference numeral 10 in the drawings. The dishwasher 10 includes a cabinet 12 defining a washing chamber 14. A door 16 is hinged to the cabinet 12 so as to be movable between open and closed positions.

The dishwasher 10 includes an upper rack 18, a lower rack 20, and a middle rack 22. Each of the racks 18, 20, and 22 are rollably or slideably supported by the side walls of the cabinet 12 for movement between a retracted position within the washing chamber 14 and an extended position substantially out of the washing chamber 14 and overlying the door 16. While the racks 18, 20, 22 may have various structures or configurations, a preferred embodiment is shown in Applicant's co-pending application Ser. No. 10/156,414, entitled THREE RACK DISHWASHER and filed on May 28, 2002, which is incorporated herein by reference.

The inside wall or surface 24 of the door 16 includes a recessed area 26 adjacent the lower portion of the door. A plurality of hooks 28 are provided in the recessed area 26 of the door 16. Preferably, the hooks 28 are integrally molded with the inside wall 24 of the door 16.

A pair of silverware or utensil baskets 30 are removably mounted on the hooks 28 on the inside of the door 16. It is understood that as an alternative to a pair of baskets 30, a single enlarged basket can be utilized. Each basket 30 includes a back wall 32, a front wall 34, a bottom wall 36, and opposite side walls 38 which define a receptacle for holding silverware, utensils, and other small objects to be washed in the dishwasher 10. A cover 40 removably mounted to the basket 30. Alternatively, the cover 40 may be hinged to the back wall 32 of the basket 30 so as to be movable between open and closed positions with respect to the open upper end of the baskets 30. Each basket 30 also includes a handle 42 which extends upwardly along the inside wall 24 of the door 16.

The back wall 32 of each basket 30 includes a pair of slots or recesses 44 adapted to receive the hooks 28 on the door 16. The slots 44 allow the baskets 30 to be quickly and easily hung or mounted on the hooks 28. The baskets 30 can be removed from the door for loading and/or unloading, as desired by the user.

A detergent dispenser 46 and a rinse agent dispenser 48 are also provided on the inside wall 24 of the door 16. The detergent container 46 and the rinse agent dispenser 48 are conventional and do not constitute part of the present invention.

The baskets 30 reside within the recessed area 26 of the door 16 such that the lower rack 20 can move outwardly to the extended position without removing the baskets 30 from the door 16. The depth of the baskets 30 is sized so that when the door 16 is closed, the baskets 30 do not interfere or engage with the racks 18, 20, 22. Also, at least the lower and middle racks 20, 22 may be slightly shorter in length from front to back than the upper rack 18 so as to accommodate the baskets 30 when the door 16 is closed.

Whereas the invention has been shown and described in connection with the preferred embodiment thereof, it will be understood that any modifications, substitutions, and additions may be made which are within the intended broad scope of the following claims. From the foregoing, it can be seen that the present invention accomplishes at least all of the stated objectives.

1. A dishwasher, comprising:
a cabinet defining a washing chamber;
a door pivotally mounted to the cabinet for movement between open and closed positions, and having an inside surface facing the washing chamber when the door is in the closed position;
an upper rack, lower rack, and middle rack mounted to the cabinet for movement between extended and retracted positions; and
a silverware basket removably mounted to the inside surface of the door.

2. The dishwasher of claim 1 wherein the inside surface of the door includes hooks for releasably mounting the basket to the door.

3. The dishwasher of claim 1 wherein the basket includes front, back, bottom and side walls defining a receptacle with an open upper end for receiving objects to be washed, and a top wall movable between open and closed positions relative to the upper end.

4. The dishwasher of claim 3 wherein the basket top wall is removable relative to the upper end.

5. The dishwasher of claim 3 wherein the basket further includes a handle extending upwardly along the inside surface of the door.

6. The dishwasher of claim 1 further comprising a second silverware basket removably mounted to the inside surface of the door.

7. The dishwasher of claim 5 wherein the first and second silverware baskets are separate from one another.

8. The dishwasher of claim 1 wherein the inside surface of the door is recessed and the basket resides substantially within the recess with the lower rack overlying the basket when in the extended position.

9. A dishwasher comprising:
a cabinet with a door;
three racks mounted in the cabinet for movement between extended and retracted positions;
a silverware basket mounted on the door;
the door having molded hooks for releasably mounting the basket to the door.

10. The dishwasher of claim 9 wherein the basket includes a pivotal cover movable between open and closed positions.

11. The dishwasher of claim 9 further comprising a cover removably mounted on the basket.

12. The dishwasher of claim 9 wherein the basket includes an upwardly extending handle.

13. The dishwasher of claim 9 further comprising a second silverware basket removably mounted to the inside surface of the door.

14. The dishwasher of claim 13 wherein the first and second silverware baskets are separate from one another.

15. The dishwasher of claim 13 wherein the baskets are positioned side-by-side on the door.

16. The dishwasher of claim 9 wherein the hooks are integrally formed with the inside surface of the door.
